(19) United States
(12) Patent Application Publication
(10) Pub. No.: US 2015/0194099 A1
(43) Pub. Date: Jul. 9, 2015

(54) Information Processing Apparatus and Information Processing Method

(71) Applicant: Kabushiki Kaisha Toshiba, Tokyo (JP)

(72) Inventors: Hideki Watanabe, Ome (JP); Keiji Kanamori, Akishima (JP)

(21) Appl. No.: 14/577,819

(22) Filed: Dec. 19, 2014

Related U.S. Application Data
(60) Provisional application No. 61/924,149, filed on Jan. 6, 2014.

(51) Int. Cl. G09G 3/34

(52) U.S. Cl. CPC G09G 3/3406; G09G 2320/0233; G09G 2320/0626

(57) ABSTRACT

An information processing apparatus includes a display, an illumination intensity sensor and a controller. The display has a display screen. The illumination intensity sensor measures brightness in a periphery of the display screen. The controller collects and accumulates levels of a luminance of the display screen set by a user for each of levels of the brightness.

### CROSS-REFERENCE TO RELATED APPLICATION

This application claims priority from U.S. Provisional Patent Application No. 61/924,149 filed on Jan. 6, 2014, the entire contents of which are incorporated herein by reference.

### FIELD

The present invention relates to an information processing apparatus and an information processing method.

### BACKGROUND

A portable information device, for instance, a note PC or a tablet has an ALS (an illumination intensity sensor, an ambient light sensor) mounted and is provided with an automatically adjusting function of a screen luminance corresponding to an ambient light. However, in the “automatically adjusting function”, there are only selection subjects of “used” and “not used” by a user and a “screen luminance desired by a user” meeting an ambient luminance cannot be set. As a result, a problem arises that the user needs to nullify the function and manually adjust the luminance.

### BRIEF DESCRIPTION OF DRAWINGS

FIG. 1 is a diagram schematically showing an external appearance of an information processing apparatus according to an embodiment.

FIG. 2 is a block diagram showing one example of a hardware structure of the information processing apparatus according to the present embodiment.

FIG. 3 is a system block diagram of an information device shown for explaining functions of the present embodiment.

FIG. 4 is a diagram showing an example of a corresponding relation of an “automatic control of an LCD luminance corresponding to an ambient light” using an ALS of the present embodiment.

FIG. 5 is a diagram showing an example of accumulated data (shown by dot marks) of the ambient light used in the present embodiment and a luminance set by a user

FIG. 6 is a corresponding diagram (shown by void arrow marks) of an “automatic control of an LCD luminance corresponding to an ambient light” which is newly defined in accordance with a using state of the user in the present embodiment.

FIG. 7 is a flowchart used in the present embodiment and showing that the accumulated data is prepared and processed in accordance with the using state of the user in the present embodiment.

### DETAILED DESCRIPTION

According to one embodiment, an information processing apparatus includes a display, an illumination intensity sensor and a controller. The display has a display screen. The illumination intensity sensor measures brightness in a periphery of the display screen. The controller collects and accumulates levels of a luminance of the display screen set by a user for each of levels of the brightness.

Various Embodiments will be described hereinafter with reference to the accompanying drawings.

Now, by referring to the attached drawings, an information processing apparatus and an information processing method according to an embodiment will be described below.

In the below-described embodiment, the information processing apparatus provided with a slate type casing such as PDA (Personal Digital Assistants) or a portable telephone will be described as an example.

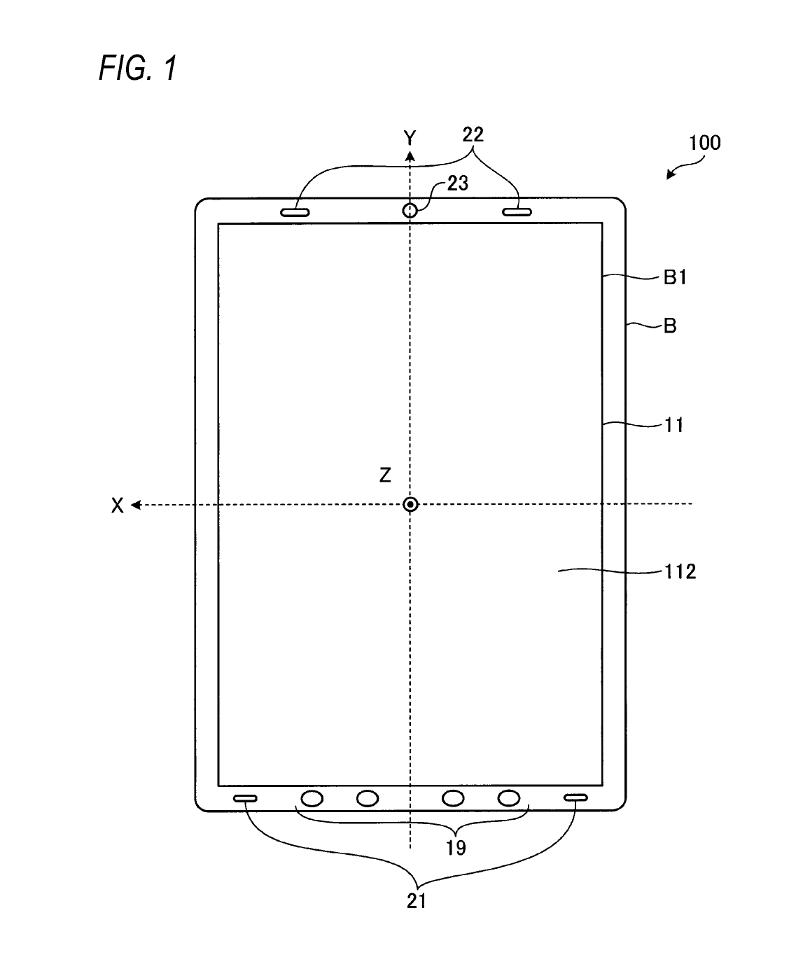

FIG. 1 is a diagram schematically showing an external appearance of the information processing apparatus according to the present embodiment. The information processing apparatus 100 according to the present embodiment is a slate type information processing apparatus including a display 11 having a display screen 112 and is realized as, for instance, a slate terminal (a tablet terminal), an electronic book reader or a digital photograph frame or the like. Here, directions shown by arrow marks (in a Z-axis, a forward direction in the drawing) in an X-axis, a Y-axis and a Z-axis are set as forward directions.

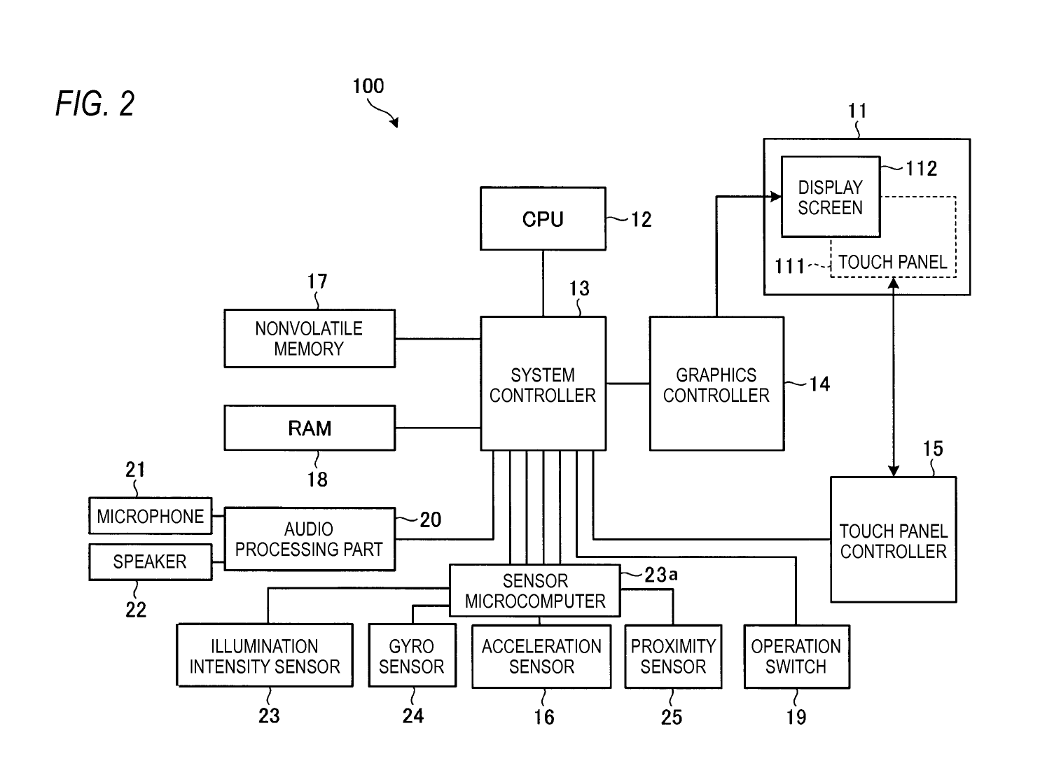

The information processing apparatus 100 includes a thin box shaped (a slate type) casing B. The casing B accommodates therein the display 11. In the present embodiment, the casing B is provided with a surface (refer it to as an upper surface, hereinafter) having an opening part B1 which exposes the display screen 112 of the display 11. The display 11 has a touch panel 111 (see FIG. 2) which detects a position on the display screen 112 touched by a user. Further, in a lower part of the upper surface of the casing B, are arranged operation switches 19 by which the user carries out various kinds of operations and microphones 21 which obtain a voice of the user. Further, on an upper part of the upper surface of the casing B, speakers 22 are arranged which output an audio. Further, on an edge of the casing B, a connector (not shown in the drawing) to which a head-phone or an earphone for outputting an audio can be connected is arranged. Further, on the upper part of the upper surface of the casing B, an illumination intensity sensor 23 which detects an ambient brightness is arranged.

FIG. 2 is a block diagram showing one example of a hardware structure of the information processing apparatus according to the present embodiment. As shown in FIG. 2, the information processing apparatus 100 according to the present embodiment includes, in addition to the above-described structure, a CPU (a Central Processing Unit) 12, a system controller 13, a graphics controller 14, a touch panel controller 15, an acceleration sensor 16, a nonvolatile memory 17, a RAM (a Random Access memory) 18, an audio processing part 20, a gyro sensor 24 and a proximity sensor 25.

The display 11 includes the touch panel 111 and the display screen 112 such as an LCD (a Liquid Crystal Display) or an organic EL (Electro Luminescence). The touch panel 111 is a coordinate detector arranged on, for instance, the display screen 112. The touch panel 111 detects the position (a touch position) on the display screen 112 touched by a finger of the user who holds the casing B.

The CPU 12 is a processor which controls respectively the parts of the information processing apparatus 100 through the system controller 13. The CPU 12 executes various kinds of application programs of an operating system (OS), a web browser or software used for preparing a text which are loaded to the RAM 18 from the nonvolatile memory 17.

The nonvolatile memory 17 stores the operating system, programs such as various kinds of application programs or various kinds of data. The RAM 18 provides a working area when the CPU 12 executes the programs.

In the system controller (functions also as an I/O controller) 13, a memory controller is incorporated which controls an access to the nonvolatile memory 17 and the RAM 18. Further, the system controller 13 has a function for carrying out a communication with the graphics controller 14.

The graphic controller 14 is a display controller which controls the display screen 112. The touch panel controller 15 controls the touch panel 111 to obtain coordinate data showing the touch position on the display screen 112 touched by the user from the touch panel 111.

The illumination intensity sensor 23 is, for instance, a photo-diode or the like which detects the ambient brightness of the information processing apparatus 100. In the present embodiment, the illumination intensity sensor 23 is arranged on the upper surface of the casing B as described above to output to the CPU 12 a brightness signal showing a forward brightness of the display screen 112, namely, the ambient brightness of the information processing apparatus 100.

The gyro sensor 24 detects rotation angles when the information processing apparatus 100 rotates on the X-axis, the Y-axis and the Z-axis respectively. Then, the gyro sensor 24 outputs rotation angle signals which show the rotation angles respectively on the axes of the X-axis, the Y-axis and the Z-axis to the CPU 12.

The acceleration sensor 16 detects an acceleration of the information processing apparatus 100. In the present embodiment, the acceleration sensor 16 detects the accelerations respectively in the directions of the axes of the X-axis, the Y-axis and the Z-axis shown in FIG. 1 and the accelerations in rotating directions respectively on the axes. Then, the acceleration sensor 16 outputs to the CPU 12 acceleration signals which show the accelerations respectively in the directions of the axes of the X-axis, the Y-axis and the Z-axis shown in FIG. 1 and the accelerations in the rotating directions respectively on the axes.

The proximity sensor 25 is a sensor which detects in a non-contact that a body of an object to be detected approaches. Specifically, as the proximity sensor 25, are employed sensors such as a high-frequency oscillator type sensor using an electro-magnetic induction, a magnetic type sensor using a magnet and an electrostatic capacity type sensor which detects a change of an electrostatic capacity between the body of the object to be detected and the sensor. Then, when the proximity sensor 25 detects that the body of the object to be detected approaches, the proximity sensor outputs to the CPU 12 a proximity signal showing that the body of the object to be detected approaches.

Here, a sensor microcomputer 23a has a structure to which the above-described sensors (the illumination intensity sensor 23, the gyro sensor 24, the acceleration sensor 16 and the proximity sensor 25) are connected to generalize these sensors.

The audio processing part 20 applies audio processes such as a digital conversion, a noise removal, an echo cancellation or the like to an audio signal inputted from the microphones 21 and outputs the audio signal to the CPU 12. Further, the audio processing part 20 carries out an audio process such as an audio synthesis under a control of the CPU 12 and outputs the generated audio signal to the speakers 22.

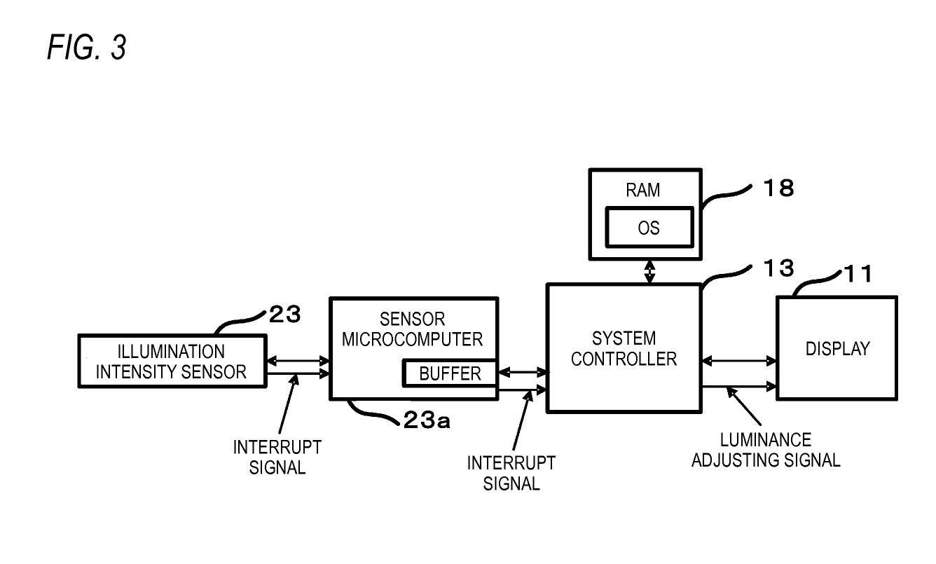

Now, by using FIG. 3, a functional structure as a main part of the information processing apparatus 100 according to the present embodiment will be described below. FIG. 3 is a block diagram showing the functional structure of the information processing apparatus 100 according to the present embodiment. As shown in FIG. 3, the functional structure shows a process in an information device including an ALS having the illumination intensity sensor 23 and the sensor microcomputer 23a which informs an OS of sensor information, the system controller 13, the display 11 and an OS which automatically adjusts a screen luminance in accordance with an illumination intensity value.

The sensor microcomputer 23a which generalizes the illumination intensity sensor 23 is formed so as to carry out a reading process of the illumination intensity value of the illumination intensity sensor 23, for instance, at prescribed intervals, set the illumination intensity value to a buffer which reports to the OS and output an interruption to the OS as required.

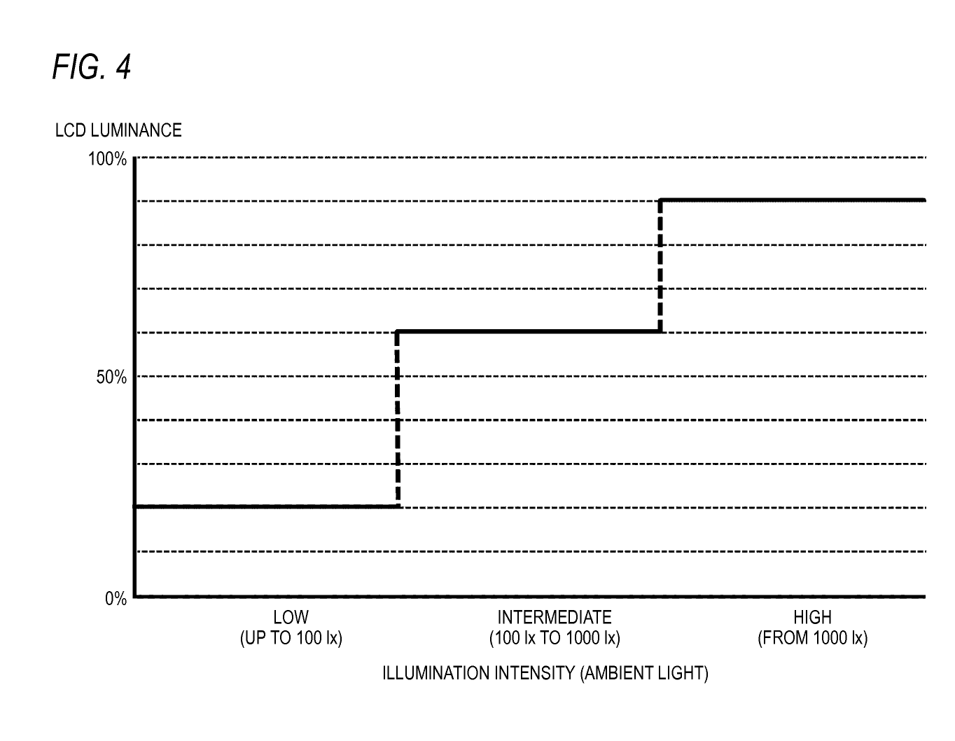

FIG. 4 is a characteristic graph showing a relation between illumination intensity and the screen luminance in the present embodiment. An axis of abscissas shows the illumination intensity (lx) and an axis of ordinates shows the screen luminance (cd/cm²). Both the axes are represented by, for instance, logarithmic axes. FIG. 4 shows a correspondence of an ambient light obtained by the ALS and a control of the screen luminance corresponding thereto. Namely, is shown an example of a table of an “automatic control of LCD luminance corresponding to the ambient light” using the ALS.

In this example, a level of the illumination intensity (the ambient light) is sorted into a “low” level (a dark indoors is imagined), an “intermediate” level (an indoors and a position below a fluorescent lamp are imagined) and a “high” level (an outdoors or the like). Further, the screen luminance is supposed to be prescribed in ten levels. A prescribed luminance is supposed to be defined for each of the levels of the illumination intensity.

For instance, the “illumination intensity of the ambient light obtained by the ALS” and “information of the screen luminance” is accumulated or stored by either of below-described methods (a) and (b).

(a) When automatic setting of luminance by ALS is valid

When the user changes a luminance setting, the “illumination intensity of the ambient light obtained by the ALS” and the “screen luminance set by the user” are recorded and accumulated or stored.

(b) When automatic setting of luminance by ALS is not valid

When the user changes the luminance setting in cases of AC drive/battery drive respectively, the “illumination intensity of the ambient light obtained by the ALS” and a “present screen luminance” are periodically (ex. once an hour) recorded and accumulated or stored.

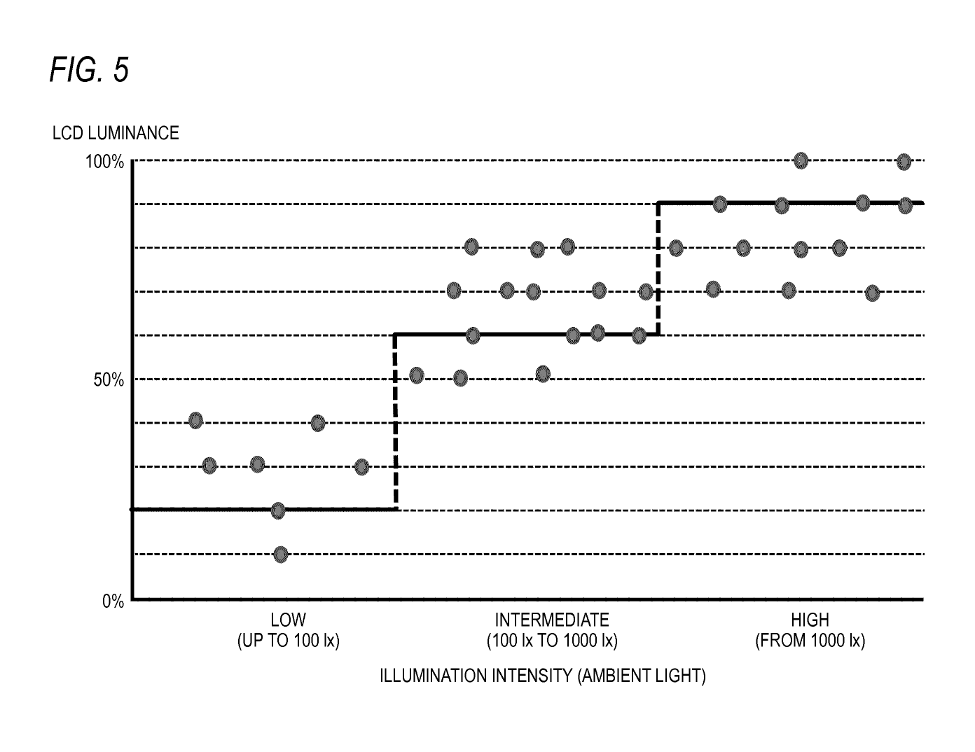

FIG. 5 is a diagram showing an example of the accumulated data (shown by dot marks) of the ambient light used in the present embodiment and the luminance set by the user. Namely, FIG. 5 shows the accumulated data on the graph of the corresponding relation between the ambient light and the screen luminance by the dot marks.

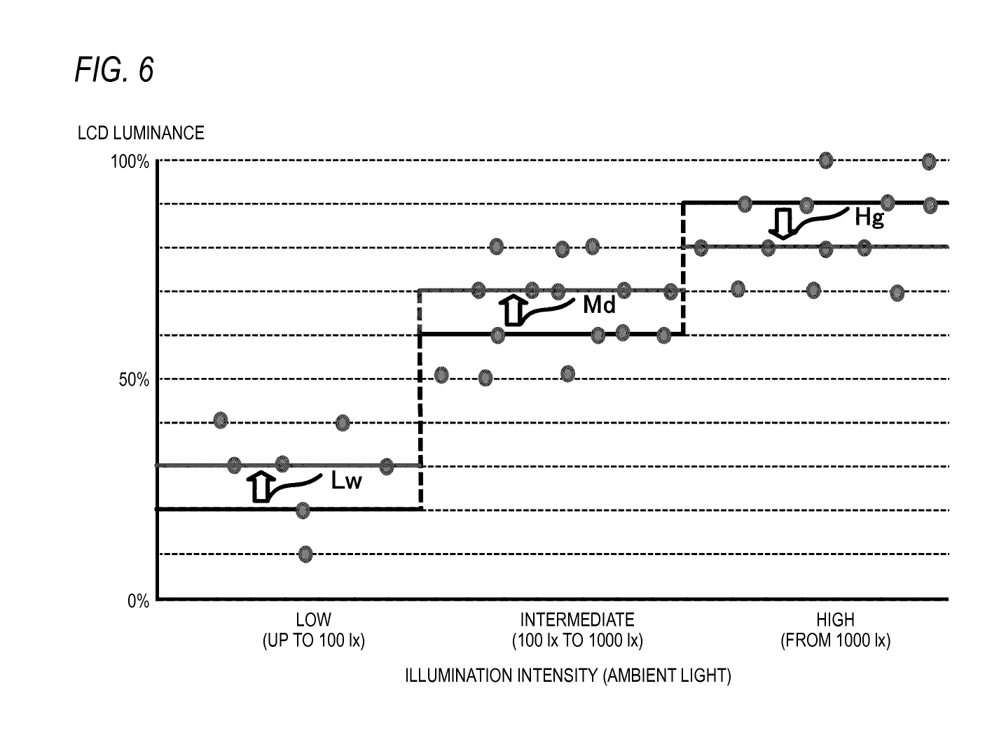

For all the levels of the illumination intensity respectively, when the data of, for instance, 5 points or higher is accumulated, an average value of the screen luminance data obtained by the above-described (a) or (b) is calculated. The calculated average value of the screen luminance is defined as a “new table of “the ambient light vs the screen luminance”” and is reflected on the screen luminance as shown in FIG. 6.

FIG. 6 is a corresponding diagram (shown by void arrow marks) of the “automatic control of the LCD luminance corresponding to the ambient light” which is newly defined in accordance with a using state of the user in the present embodiment. Namely, is shown an example of a table of the “automatic control of the LCD luminance corresponding to the ambient light” which is newly defined in accordance with the using state of the user. The table shows a corresponding relation between the “illumination intensity of the ambient light” and the “screen luminance” which is newly defined.

The data of the ambient light and the screen luminance setting is continuously obtained. When there is a dissociation between the data of the ambient light and the screen luminance and the luminance table defined as described above, the luminance table is looked at again (a moving average is taken, for instance, just before five times). The data is accumulated when the user does not allow an “automatic adjustment of the screen luminance by the ALS” to be valid so as to prepare for a time when the user allows this function to be valid.

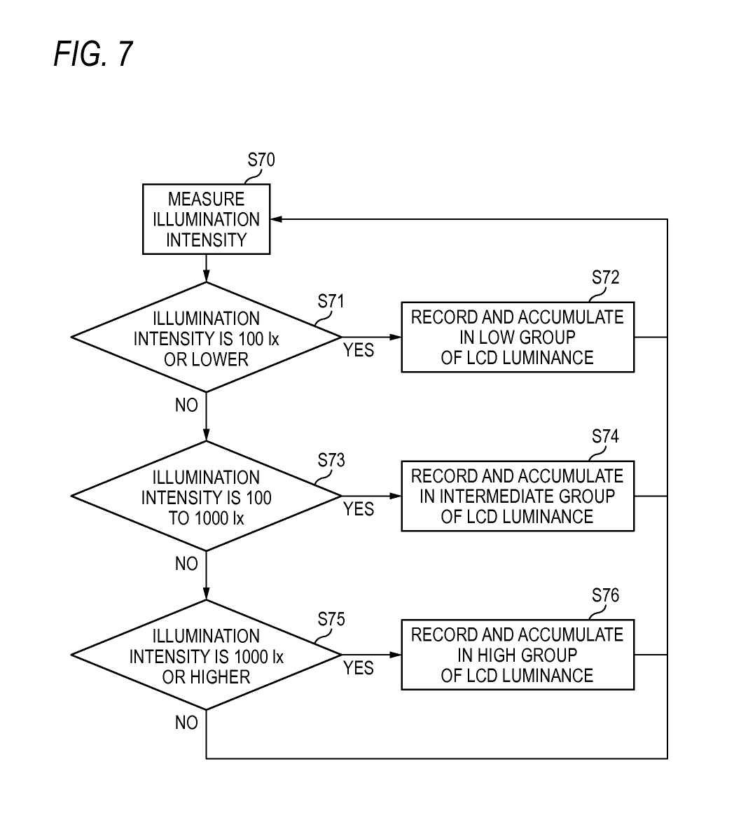

FIG. 7 is a control flowchart used in the present embodiment in which the accumulated data is prepared and processed with such an image as shown in FIG. 5 in accordance with the using state of the user. A “state of a power source (a sort of the AC drive/the battery drive)” is also recorded, and the above-described control is carried out respectively during the AC drive/during the battery drive. Step S70 in FIG. 7 is started when the above-described OS automatically adjusts the screen luminance in accordance with the illumination intensity value obtained from the ALS through the system controller 13. Below-described steps of what is called a controller of the information processing apparatus are continuously carried out mainly in the OS.

Step S70: The OS allows the ALS to measure the illumination intensity.
Step S71: The OS advances to a process of step S72 when a result of the measurement of the illumination intensity is 100 lx or lower. Otherwise, the OS advances to step S73.
Step S72: The OS carries out such a record and accumulation as described below in a low group of the LCD luminance and returns to the step S70.
Step S73: The OS advances to a process of step S74 when a result of the measurement of the illumination intensity exceeds 100 lx and is lower than 1000 lx. Otherwise, the OS advances to step S75.
Step S74: The OS carries out such a record and accumulation as described below in an intermediate group of the LCD luminance and returns to the step S70.
Step S75: The OS advances to a process of step S76 when a result of the measurement of the illumination intensity is 1000 lx or higher. Otherwise, the OS returns to the step S70 (including a case that the result is not obtained due to an error or the like).
Step S76: The OS carries out such a record and accumulation as described below in a high group of the LCD luminance and returns to the step S70.

In the case of the data shown in FIG. 5, for instance, the average value is obtained by a below-described calculation to obtain a result thereof as an expected value of the user.

In a low area of the illumination intensity (up to 100 lx), are selected seven points in total including one point of 10%, one point of 20%, three points of 30% and two points of 40%. When an average of the LCD luminance low group is taken, ((10+20+30×3+40×2)/6)=33(%) is obtained. Thus, a present set value is adjusted so that the stage of the level is changed from 20% to 30% as shown by a void arrow mark Lw.

In an intermediate area of the illumination intensity (100 lx to 1000 lx), are selected fifteen points in total including three points of 50%, four points of 60%, five points of 70% and three points of 80%. When an average of the LCD luminance intermediate group is taken, ((50×3+60×4+70×5+80×3)/15)=65(%) or higher is obtained. Thus, a present set value is adjusted so that the stage of the level is changed from 60% to 70% as shown by a void arrow mark Md.

In a high area of the illumination intensity (from 1000 lx), are selected thirteen points in total including three points of 70%, four points of 80%, four points of 90% and two points of 100%. When an average of the LCD luminance high group is taken, ((70×3+80×4+90×4+100×2)/13)=84(%) is obtained. Thus, a present set value is adjusted so that the stage of the level is changed from 90% to 80% as shown by a void arrow mark Hg.

As described above, when an adjustment of the luminance which meets the using state or a preference of the user is added to the automatically adjusting function of the screen luminance using the ALS, a convenience of the user is improved. As an effect of the embodiment, a “plurality of” data of the luminance set by the user under various kinds of environments which have different illumination intensities (the ambient lights) are accumulated and statistically provided, so that the luminance can be automatically adjusted to a luminance more preferred by the user.

Initially, in the portable information device in which the ALS is mounted and the luminance of the screen can be adjusted by the user, the “illumination intensity of the ambient light obtained by the ALS” and the “set value of the screen luminance set by the user” can be collected and accumulated. In other devices than the portable information device, for instance, a movement of a television mounted on a carriage beside a window, or a change of outside light due to the weather or time and a variation due to the degree of an interior illumination are effectively met.

When a new “table of the ambient light and the screen luminance” is calculated and defined on the basis of the accumulated data of the “illumination intensity of the ambient light” and the “screen luminance”, the screen luminance corresponding to the ambient light can be automatically adjusted. Further, the new “table of the ambient light and the screen luminance” may be continuously calculated and defined, and the table may be updated each time depending on the using state or the preference of the user.

The present invention is not limited to the above-described embodiment, and may be variously modified and embodied in addition thereto within a range which does not deviate from a gist thereof.

Further, when a plurality of component elements disclosed in the above-described embodiment is suitably combined together, various inventions may be devised. For instance, some component elements may be deleted from all the component elements shown in the embodiment. Further, component elements according to different embodiment may be suitably combined together.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display having a display screen;
an illumination intensity sensor that measures brightness in a periphery of the display screen; and
a controller that collects and accumulates levels of a luminance of the display screen set by a user for each of levels of the brightness.

2. The information processing apparatus according to claim 1,
wherein, when an expected value of the level of the luminance is different from a set value of a present level of the luminance, the controller controls the set value to correspond to the expected value.

3. The information processing apparatus according to claim 2,
wherein the expected value is prescribed by an average value of the luminance for each of the levels of the brightness.

4. An information processing method in an information processing apparatus including a display having a display screen and an illumination intensity sensor which measures brightness in a periphery of the display screen, the information processing method including:
measuring the brightness in the periphery of the display screen; and
controlling and accumulating levels of a luminance of the display screen set by a user for each of levels of the brightness.

5. The information processing method according to claim 4,
wherein when an expected value of the level of the luminance is different from a set value of a present level of the luminance, the set value is controlled to be corresponded to the expected value.

6. The information processing method according to claim 5,
wherein the expected value is prescribed by an average value of the luminance for each of the levels of the brightness.
